(19) United States
(12) Patent Application Publication
(10) Pub. No.: US 2021/0044314 A1
(43) Pub. Date: Feb. 11, 2021

(54) DATA COMMUNICATION SENSING AND MONITORING SYSTEM MOUNTABLE IN SUPPORT STRUCTURE

(71) Applicant: 3M INNOVATIVE PROPERTIES COMPANY, St. Paul, MN (US)

(72) Inventors: Ernesto M. Rodriguez, Jr., Georgetown, TX (US); Steven E. Turch, Blaine, MN (US)

(21) Appl. No.: 15/733,607

(22) PCT Filed: Mar. 15, 2019
(86) PCT No.: PCT/IB2019/052135

§ 371 Date: Sep. 15, 2020

Related U.S. Application Data
(60) Provisional application No. 62/646,418, filed on Mar. 22, 2018.

(51) Int. Cl. H04B 1/40; H04B 17/309

(52) U.S. Cl. CPC H04B 1/40; H04B 17/309

(57) ABSTRACT

A data communication system comprises a transceiver including an antenna and global positioning system (GPS) circuitry, disposed in a support structure adjacent to and supporting an entrance port to an underground enclosure. The transceiver includes a housing, where the housing is flush mountable in the support structure, wherein the transceiver is configured to communicate with a network outside of the underground enclosure. The data communication system also includes a sensor disposed in the enclosure that provides data related to a real-time condition within the underground enclosure. The data communication system also includes a sensor analytics unit to process the data from the sensor and generate a processed data signal and to communicate the processed data signal to the transceiver.

### BACKGROUND

Machine to machine communication is becoming increasingly important to the energy, communications, and security markets, among others. Supervisory Control and Data Acquisition (SCADA) systems used in those industries rely on inputs from remotely located sensors to function properly. SCADA systems can also output signals to actuate remote equipment in the field. A sizeable portion of that equipment (˜18% for U.S. electric utilities) is located underground, and providing wireless communications between above ground and underground equipment is a serious challenge.

Current methods used to locate underground cable faults are still slow and labor intensive. Even relatively short outages can be used against utilities and lead to rate adjustments for customers, so a faster means of locating and fixing underground faults is needed.

Thus, there is a need for communicating wireless signals into and out of underground equipment vaults and other structures where underground equipment is located.

### SUMMARY OF THE INVENTION

In one aspect of the invention, a data communication system comprises a transceiver including an antenna and global positioning system (GPS) circuitry, disposed in a support structure adjacent to and supporting an entrance port to an underground enclosure. The transceiver includes a housing, where the housing is flush mountable in the support structure, wherein the transceiver is configured to communicate with a network outside of the underground enclosure. The data communication system also includes a sensor disposed in the enclosure that provides data related to a real-time condition within the underground enclosure. The data communication system also includes a sensor analytics unit to process the data from the sensor and generate a processed data signal and to communicate the processed data signal to the transceiver.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The invention will be described hereinafter in part by reference to non-limiting examples thereof and with reference to the drawings, in which:

FIG. 1 is an isometric sectional view of an exemplary vault with the data communication system according to an embodiment of the present invention.

FIG. 2 is sectional view of the transceiver unit of the data communication system according to an embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

In one aspect of the present invention, a data communication system includes a robust transceiver that communicates between a vault or underground enclosure and a utility, service, or monitoring network, and that is securely flush mounted in the support structure, such as a concrete pad, for the associated vault or underground enclosure. The transceiver includes an active antenna to provide radio transmission regarding accurate, real-time equipment conditions, with GPS electronics to provide positional information. This antenna/transceiver can take a combination of data signals from monitoring device(s)/sensor(s)/sensor analytics unit(s) which provide real-time data regarding environmental, component, and other electronic equipment conditions for those components/equipment disposed within the underground vault or enclosure. By mounting the transceiver in the concrete support pad, the vault or underground enclosure can be entered without disrupting the data communication system or displacing the transceiver.

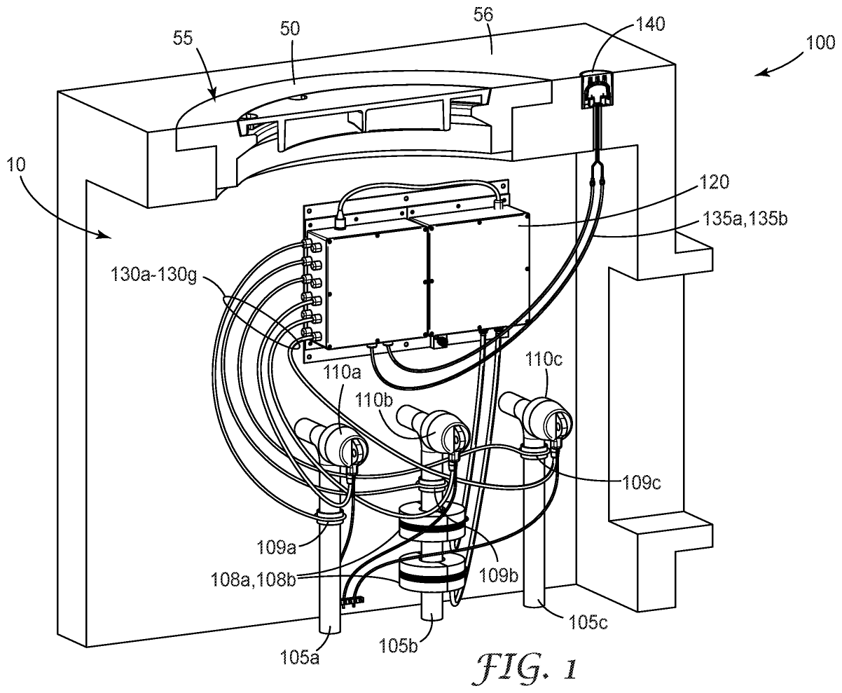

FIG. 1 shows one aspect of the present invention, a data communication system 100. In this aspect, the data communication system 100 is an underground data communication system. The communications system 100 is disposed in an exemplary underground enclosure, here underground vault 10. In this example implementation, vault 10 includes a variety of equipment, such as one or more high voltage electrical lines, such as electrical lines 105a-105c (carrying e.g., low, medium or high voltage power), associated components and/or accessories, such as a splice or termination, a transformer, and further electrical lines to a nearby building or structure. In some vaults, a transformer may not be included therein.

The enclosure or vault 10 can be accessed from above ground via a portal or entrance port 55 that includes a conventional manhole cover 50, which can be formed from a metal and can have a conventional circular shape. In a one aspect, the manhole cover can be mounted on a ring, frame or flange structure of the entrance port 55 that is formed within a concrete pad or support structure 56 that covers and protects the vault or underground enclosure 10. In some instances, the support structure comprises a reinforced (with a rebar lattice) concrete pad, a thick metal plate, or a combination of a concrete pad with a metal cover plate surrounding the entrance port/manhole cover. In this aspect, vault 10 is can be constructed as a conventional underground vault, commonly used by electric, gas, water, and/or other utilities. However, in alternative aspects, the underground data communication system 100 can be utilized in another type of underground enclosure or similar structure, such as a manhole, basement, cellar, pit, shelter, pipe, or other underground enclosure.

The data communication system 100 further includes a transceiver unit 140 securely mounted within the concrete pad or support structure 56. In this manner, communication from the vault to an outside network can be accomplished, as communicating radio signals through a metal manhole cover or a reinforced concrete pad, with supporting rebar disposed throughout, is extremely difficult and/or severely limited. A data communication system mountable to a vault entrance or manhole cover is described in PCT Pub. No. WO 2015/195861, incorporated by reference herein in its entirety.

The vault 10 also includes at least one sensor or monitoring device disposed therein which can monitor a physical condition of the vault or of the components or equipment located in the vault. Such conditions would normally be difficult to gather or assess from above-ground. As described in detail below, the underground data communication system can provide a communication infrastructure to relay vault condition information to an above ground network or SCADA, without having a service technician physically enter the vault to determine those conditions.

As shown in FIG. 1, in this example, the sensors include voltage test points 110a-110c and Rogowski coils (current sensors) 109a-109c, that are deployed for a power cable, such as a low, medium or high voltage power cable 105a-105c. Other sensors can be provided that measure a cable condition, such as voltage, current, and/or temperature. Thus, in this example, the sensors can provide real-time data about the condition of one or more connected power lines.

For example, the Rogowski coils 109a-109c each produce a voltage that is proportional to the derivative of the current, meaning that an integrator can be utilized to revert back to a signal that is proportional to the current. Alternatively, a current sensor can be configured as a magnetic core current transformer that produces a current proportional to the current on the inner conductor. In addition, the voltage test points 110a-110c can each include a capacitive voltage sensor that provides precise voltage measurements. Because both a current sensor and a capacitive voltage sensor are provided in this example, these sensors facilitate calculation of phase angle (power factor), Volt Amps (VA), Volt Amps reactive (VAr), and Watts (W). Alternatively, a sensored termination can be deployed, such as is described in U.S. Provisional Application No. 61/839,543, incorporated by reference herein in its entirety.

Overall, it is contemplated that the data communication system 100 can include one or more of the following sensors: power, voltage, current, temperature, combustible materials or byproducts of combustion, mechanical strain, mechanical movement (e.g. revolutions per minute), humidity, soil condition (acidity, moisture content, mineral content), pressure, hazardous atmosphere, liquid flow, leakage, component end-of-life or lifetime (e.g., a cathodic protection sensor), personnel presence (e.g., has someone entered the enclosure), physical state (e.g., is the enclosure open or closed, is the door open or closed, is a switch or valve open or closed, has an item been tampered with), light sensor, vibration (seismic, tampering). For example, the data communication system can be implemented with a series of environmental sensors, such as gas (e.g., CH4, H2S, CO, etc.), water, and temperature (or humidity). Each sensor can have a hardware programmable unique I2C address. In addition, the sensors can each have one or more separate probes that extend into the environment (e.g., they can be sealed for continuous submersion in some applications).

In some aspects, the data communication system 100 can interpret monitoring device/sensor information to determine environmental conditions such as the presence of hazardous gases, moisture, dust, chemical composition, corrosion, pest presence, and more. Further, the data communication system can send aggregated information such as periodic status or asynchronous alarm notifications upstream to another aggregation node or cloud server above ground. The data communication system can also respond to messages sent to it by an upstream aggregation node or cloud (e.g., SCADA) service. Typical commands from an upstream node or cloud service can include “transmit status,” perform action,” “set configuration parameter,” “load software,” etc.

As shown in FIG. 1, in this example, data from the sensors 109a-109c and 110a-110c can be communicated via one or more communication cables (here cables 130a-130f) to a sensor analytics unit (or SAU) 120. The SAU 120 can be mounted at a central location within the vault 10, or along a wall or other internal vault structure.

In one aspect, SAU 120 is adapted to process data signals received from vault sensors and transform such data signals into signals useable for an interested party (e.g., the utility that owns the vault 10) and/or in a supervisory control and data acquisition (SCADA) system. In addition, SAU 120 can also be adapted to receive signals from the SCADA system to control one or more components or equipment located in the vault. As shown in FIG. 1, data can be communicated between SAU 120 and a transceiver unit 140 (described below) via signal cables 135a,135b, which can comprise conventional coaxial cable.

The SAU 120 can include a microcontroller or microprocessor unit, a power source, and electronics that can be built into or attached onto (via an interface connector panel) an enclosure, such as an IP68 rated enclosure or equipment cabinet. The data communication system 100 can further include an integrated sensor and/or a port or interface for connecting/attaching one or more (additional) sensors directly to the SAU 120. The module can be molded or machined to be made out of a thermoplastic or other types of molded materials. In some aspects the sensors can be remotely configurable via software updates received by the data communication system. In one aspect, sensor dongles can extend the sensor heads to various places in an underground environment.

The microcontroller or microprocessor 120 can comprise one or more chips or electronic devices that can provide operational control for the transceiver 140 and monitoring device or sensor 130. In addition, the controller chips can be configured to require only low power levels, on the order of less than 10 W. The data communication system can integrate a very low power (e.g., <3 W), highly computational chipset with time synchronized events and configurable sensors 130. In addition, in one aspect, the integration of GPS capabilities along with time synchronous events leads to finding problem conditions with early detection with set thresholds and algorithms for a variety of incipient applications/faults/degradation of key structural or utility components.

One or both of the microcontroller or microprocessor 120 and the monitoring device or sensors can comprise appropriate circuits and/or electronics to read sensor data, analyze the data, aggregate the data, classify the data, infer conditions based on the data, and take action based on the data. In addition, the SAY can include a clock source (not shown) for event correlation.

The communication system 100 further includes a transceiver unit 140 that communicates information from (and to) the SAU 120 to (and from) the above ground SCADA or wireless communications network.

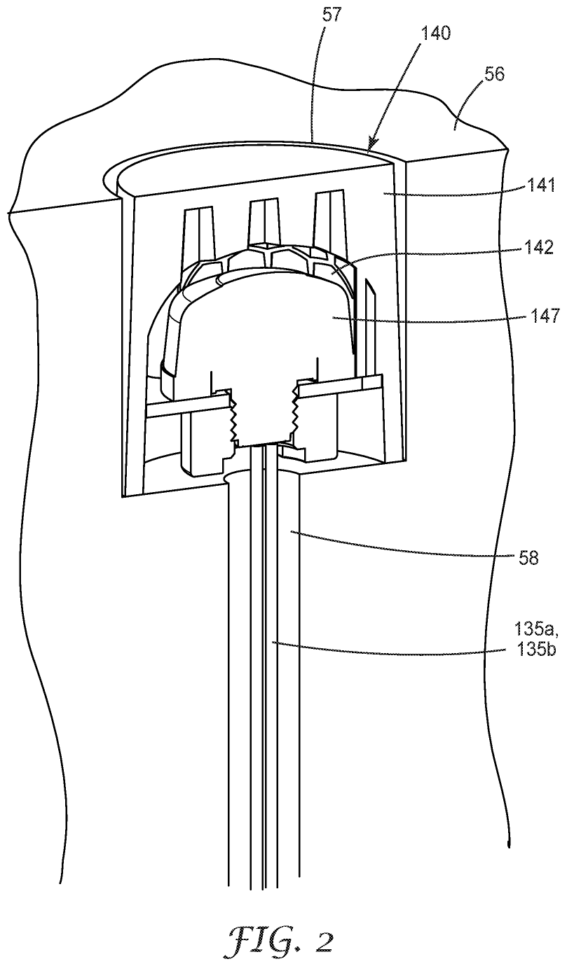

As shown in more detail in FIG. 2, transceiver unit 140 includes a housing 141 having a main body portion 142. The transceiver body 147 includes an antenna module and a GPS module disposed therein. Alternatively, the antenna module/GPS module may comprise a combination assembly, such as a MA131 Hercules antenna, that includes a GPS/GLONASS and 915 MHz ISM Band antenna (available from Taoglas Antenna Solutions). In this configuration, transceiver unit 140 is mounted in a hole or recessed portion 57 of concrete pad or support structure 56. In one alternative aspect, besides the GPS and antenna components, the transceiver unit 140 may further include processors, data storage units, communications interfaces, power supplies, and human interface devices.

The housing 141 can be a sealed, robust structure and may include one or more housing parts such as a cover and base plate. At least some of the housing parts may be made of a moldable plastic material. The transceiver unit/housing can be molded from a thermoplastic, machined, extruded, or it can be constructed from a conventional manufacturing process. The material of the housing parts may be resistant against aggressive substances. The housing can be sealed to protect the antenna and GPS components contained within it. By using a seal of appropriate material, such as a graphite-containing material, a seal may additionally be provided against aggressive substances like gasoline or oil which may be present in an outside environment.

The transceiver 140 can be mounted using a conventional potting material and/or adhesive, such as those used in pavement marking applications, to secure the transceiver position within the concrete pad 56. In addition, a channel 58 can be provided in the concrete pad 56 to allow for passage of the one or more data signal cables 135a, 135b to pass from the transceiver 140 to the vault equipment, such as SAU 120.

In an alternative aspect, the transceiver can also include a visual indicator, such as an LED or other light source, to visually indicate a state of the equipment in the vault. For example, a blinking or non-blinking light can indicate normal/abnormal status. Further, a slowly blinking marker light can indicate caution, and/or a fast blinking light can indicate a dangerous condition. In this example, a liquid crystal filter can be incorporated into the housing, and the LC polarity can be modulated with a microprocessor. Alternatively, the internal light source, e.g., and LED, can be directly modulated.

The antenna(s), electric or electronic components contained within the housing 141 can be active, passive, or both active and passive. Thus, the transceiver housing 141 makes it possible to mount an antenna on the outside surface of an underground vault or enclosure while allowing the antenna to be electrically connected to, e.g., SAU 120, located in the vault.

In another aspect, multiple antennas can be embedded in transceiver 140 allowing for multiple communication methods both above and below ground. For example, WiFi and 4G antennas can be embedded in the transceiver housing 141 along with a GPS antenna to provide multiple network connections along with GPS positioning and timing information. A Bluetooth antenna can be embedded in the transceiver 140 to provide local communications to personnel in close proximity to the transceiver unit. For example, a craft person driving over a transceiver/gateway unit could directly read the sensors in the vault below using Bluetooth. An RFID antenna can be embedded in the transceiver to permit reading underground sensor data with an RFID reader. Overall, in alternative aspects, communication methods such as WiFi, WiMax, mobile telephone (3G, 4G, LTE, 5G), private licensed bands, etc., can be utilized.

In another aspect, power can be provided to the components of the underground data communication system 100 through various means. In one aspect, equipment may be run via AC or DC power sources already located in the vault 10. If there is no available AC or DC power source, in another aspect, a power harvesting coil(s) 108a, 108b can be installed on electrical equipment, such as power lines 105a-105c that can provide power to the components in the vault 10. Alternatively, piezoelectric transducers can be utilized to convert the mechanical vibration found within vault 10 to electrical energy that can be stored in batteries or super capacitors. For example, a conventional piezoelectric transducer is available from Mide (www.mide.com). In another aspect, thermoelectric transducers can be utilized to convert the natural temperature differential between above ground and below ground to electrical energy. For example, see (http://www.idtechex.com/research/reports/thermoelectric-energy-harvesting-2012-2022-devices-applications-opportunities-000317.asp).

An example communications flowchart illustrating an example communication scheme involving the sensor, the transceiver and a network, such as a mobile client application, is provided in US Pub No. US 2017/0127156, incorporated by reference in its entirety.

Thus, with this construction, if a sensor, such as a voltage test point, senses a line fault, transceiver unit 140 can communicate real-time fault location information to a power utility network or SCADA system.

1. A data communication system, comprising:
a transceiver including an antenna and global positioning system (GPS) circuitry, disposed in a support structure adjacent to and supporting an entrance port to an underground enclosure, the transceiver including a housing, the housing flush mountable in the support structure, wherein the transceiver is configured to communicate with a network outside of the underground enclosure;
a sensor disposed in the enclosure that provides data related to a real-time condition within the underground enclosure; and
a sensor analytics unit to process the data from the sensor and generate a processed data signal and to communicate the processed data signal to the transceiver.

2. The data communication system of claim 1, wherein the sensor detects at least one of: temperature, combustible materials or byproducts of combustion, mechanical strain, mechanical movement, humidity, soil condition, pressure, hazardous atmosphere, liquid flow, leakage, component end-of-life or lifetime, personnel presence, physical state, light level, and vibration.

3. The data communication system of claim 1, wherein the transceiver unit includes a hardened antenna.

4. The data communication system of claim 1, wherein the transceiver is configured to send aggregated information upstream to another aggregation node or cloud server above ground.

5. The data communication system of claim 4, wherein the aggregated data comprises one or more of periodic status notification and asynchronous alarm notification.

6. The data communication system of claim 1, wherein the transceiver is configured to respond to messages sent to it by an upstream aggregation node or cloud.

7. The data communication system of claim 1, wherein the support structure comprises a concrete pad.

8. The data communication system of claim 1, the transceiver is mounted in a hole or recessed portion of the concrete pad.

9. The data communication system of claim 8, wherein the transceiver housing is substantially flush with a top surface of the concrete pad.

10. The data communication system of claim 1, further comprising a plurality of interface ports configured to connect to one or more environmental sensors.

11. The data communication system of claim 10, wherein at least one interface port provides for dongle attachment.

12. The data communication system of claim 1, further comprising a power source.

13. The data communication system of claim 1, wherein the power source comprises a power harvester.

14. The data communication system of claim 1, wherein the sensor comprises a voltage test point coupled to a power line.
